(19) United States
(12) Patent Application Publication
(10) Pub. No.: US 2008/0225942 A1
(43) Pub. Date: Sep. 18, 2008

(54) Contents reproducing apparatus

(75) Inventors: Yuta Nakamura, Ome-shi (JP); Hirofumi Mori, Koganei-shi (JP); Hirokazu Kawakatsu, Fuchu-shi (JP); Tatsunori Saito, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/072,706

(22) Filed: Feb. 27, 2008

(30) Foreign Application Priority Data
Mar. 16, 2007 (JP) 2007-069176

(51) Int. Cl. H04B 1/66

(52) U.S. Cl. 375/240.01; 386/E05.001

(57) ABSTRACT

A contents reproducing apparatus includes a receiving unit configured to receive a first packet having an ES in which encoded video or audio data is stored, and a second packet having the ES and a PCR, a counter configured to count a STC and output the counted STC as a STC value, a buffer configured to store the first and second packets in an order of reception in a time shift reproduction mode and a time shift storage mode, a correcting unit configured to correct the PCR included in the second packet received by the receiving unit by using the STC value and output the corrected PCR, in the time shift reproduction mode, and a control unit configured to control the STC in accordance with the corrected PCR and the STC value, in the time shift reproduction mode.

### CROSS-REFERENCE TO RELATED APPLICATIONS

This application is based upon and claims the benefit of priority from prior Japanese Patent Application No. 2007-069176, filed Mar. 16, 2007, the entire contents of which are incorporated herein by reference.

### BACKGROUND OF THE INVENTION

1. Field of the Invention

The present invention relates to a contents reproducing apparatus capable of reproducing video or audio data transmitted by transport stream.

2. Description of the Related Art

In a terrestrial digital broadcasting (for example, “one-segment broadcasting” in Japan) received by a 3G (3rd Generation) cellular telephone, video data is encoded in H. 264/AVC and audio data is encoded in MPEG-2 AAC. The encoded video data and audio data as called “elementary stream (ES)” are multiplexed on the transport stream in MPEG-2 SYSTEMS as a packetized elementary stream packet (PES packet) and then transmitted. Transport stream packets (TS packets) are aligned in the transport stream. A TS packet can store attribute information indicating the attribute of a bit stream composing video and audio data, a bit stream, and reference clock information called a program clock reference (PCR) for synchronizing between media such as video and audio data. The transport stream is transmitted in the wireless or wired fashion.

On the receiving side, the received TS packets are recorded. If the TS packets include the PCR, the PCR is set on a system time clock (STC) counter which counts the STC to synchronize the clock on the receiving side with the transmitting side. More specifically, the STC is adjusted (clock recovery) on the basis of a result of comparison between a value obtained by sampling the PCR in 27 MHz and the STC value on the receiving side. On the receiving side, if the STC value counted by the STC counter is equal to or greater than a presentation time stamp (PTS) included in the PES packets, the ES in the PES packets is synchronized and reproduced. In addition, a normal reproduction mode of sequentially decoding and reproducing the video and audio data in the TS packets received from the broadcast wave is known as the contents reproduction mode. Furthermore, a time shift reproduction mode of preliminarily storing the received TS packets in a buffer (time shift storing mode) when the user cannot see or hear, and sequentially decoding and reproducing the video and audio data in the TS packets stored in the buffer while storing the TS packets received from the broadcast wave in the buffer in the receiving order when the user becomes capable of see and hear, is also known.

A method of reproducing the stored data in synchronization with the STC on the transmitting side is proposed in Jpn. Pat. Appln. KOKAI Publication No. 2002-15527. More specifically, the stored data is synchronized with the STC of the transmitting side by adding the receiving time of the TS packets as the time information on storing the received TS packets, and by referring to the time information at the time of reproducing the stored data.

In the time shift reproduction mode, if the STC of the transmitting side and the receiving side cannot be synchronized and if the STC of the receiving side is later than the STC of the transmitting side, the buffer may overflow and the time shift reproduction may be broken since the amount of the data stored in the buffer continues greater than the amount of the decoded and reproduced data. In addition, even if the clock recovery is performed in the time shift reproduction mode, the PCR included in the TS packets cannot be used as an effective value for the clock recovery since the video and audio data as actually decoded and reproduced are included in the TS packets received in the time shift storing mode. In other words, normally performing the clock recovery in the time shift reproduction mode is difficult. In addition, the receiving time of the TS packets is added as the time information at the time of storing the TS packets in the method of Jpn. Pat. Appln. KOKAI Publication No. 2002-15527, but the overflow still may occur in the buffer since the data needs to be decoded and reproduced simultaneously with the data storage in the time shift reproduction mode.

### BRIEF SUMMARY OF THE INVENTION

The object of the present invention is to provide a contents reproducing apparatus capable of synchronous reproduction with the transmitting side even in the time shift reproduction mode.

According to an aspect of the invention, there is provided a contents reproducing apparatus, comprising: a receiving unit configured to receive a first packet having an elementary stream in which encoded video or audio data is stored, and a second packet having the elementary stream and a program clock reference; a counter configured to count a system time clock and output the counted system time clock as a system time clock value; a first buffer configured to store the first and second packets in an order of reception in a time shift reproduction mode and a time shift storage mode to pre-store the first and second packets prior to the time shift reproduction mode; a correcting unit configured to correct the program clock reference included in the second packet received by the receiving unit by using the system time clock value and output the corrected program clock reference, in the time shift reproduction mode; a control unit configured to control the system time clock in accordance with the corrected program clock reference and the system time clock value, in the time shift reproduction mode; a second buffer configured to temporarily store the elementary stream included in the first and second packets stored in the first buffer, in the time shift reproduction mode; a decoder configured to decode the video or audio data from the elementary stream stored in the second buffer, at a timing determined in accordance with the system time clock value; and a reproducing unit configured to reproduce the video or audio data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

FIG. 1 is a block diagram showing a contents reproducing apparatus according to an embodiment;

FIG. 2 is an illustration showing a structure of a TS packet processed in the contents reproducing apparatus shown in FIG. 1, a structure of a transport stream composed of the TS packets, and a structure of a PES packet stored in payload in the TS packet;

FIG. 3A is an illustration showing a structure of a TS header in the TS packet shown in FIG. 2;

FIG. 3B is an illustration showing a structure of Adaptation Field in the TS packet shown in FIG. 2;

FIG. 3C is an illustration showing a structure of a PES header shown in FIG. 2;

FIG. 4 is an illustration showing a state in which the TS packets are stored in the time shift storing buffer shown in FIG. 1;

FIG. 5 is an illustration showing a state in which the TS packets are stored in the time shift storing buffer shown in FIG. 1, beyond the capacity of the buffer;

FIG. 6 is a graph showing a problem in a case where the PCR is not corrected;

FIG. 7 is a graph showing correction of the PCR by a correcting unit of FIG. 1 in a case where the data in the time shift storing buffer is not overwritten;

FIG. 8 is a graph showing correction of the PCR by a correcting unit of FIG. 1 in a case where the data in the time shift storing buffer is overwritten; and

FIG. 9 is a flowchart showing a time shift reproducing operation in the contents reproducing apparatus shown in FIG. 1.

### DETAILED DESCRIPTION OF THE INVENTION

Embodiments of the present invention will be described below with reference to the accompanying drawings.

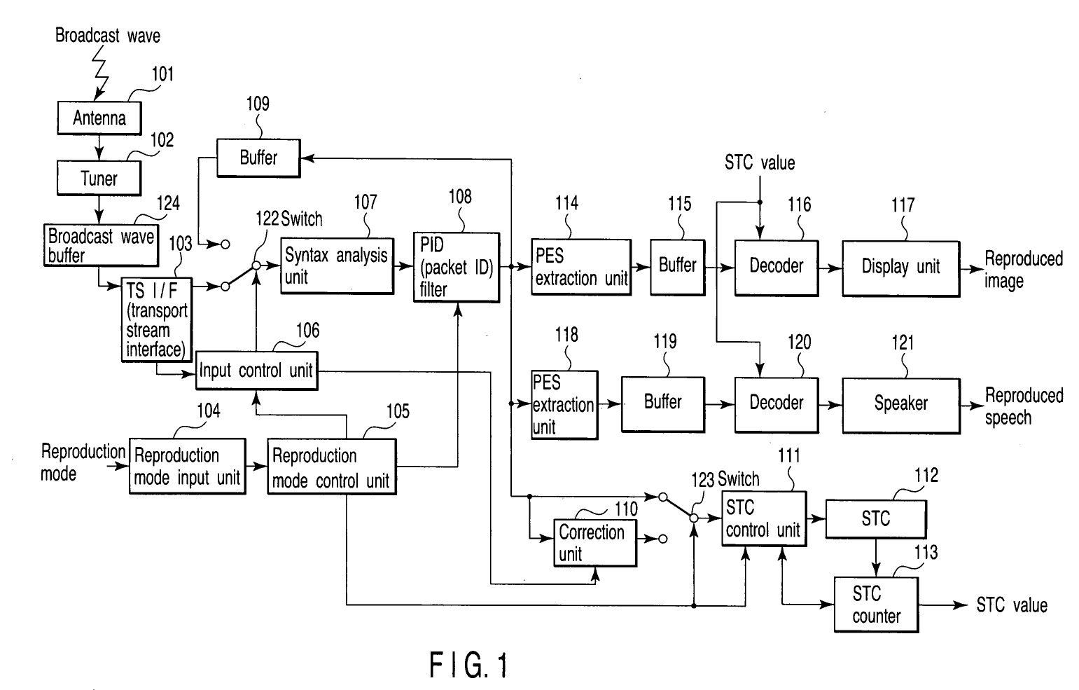

As shown in FIG. 1, a contents reproducing apparatus, such as a cellular phone, a personal computer, and a PDA, of the present invention comprises an antenna 101, a tuner 102, a TS I/F (transport stream interface) 103, a reproduction mode input unit 104, a reproduction mode control unit 105, an input control unit 106, a syntax analysis unit 107, a PID (packet ID) filter 108, a buffer 109, a correction unit 110, an STC control unit 111, an STC 112, an STC counter 113, an PES extraction unit 114, a buffer 115, a decoder 116, a display unit 117, a PES extraction unit 118, a buffer 119, a decoder 120, a speaker 121, a switch 122, a switch 123 and a broadcast wave buffer 124.

If the contents reproducing apparatus is the cellular phone, another antenna, a modem circuit for receiving radio signal from a base station and transmitting radio signal to the base station via the antenna, signal processing circuit for decoding the radio signal transferred from the modem circuit, and a speech codec are needed for usual voice communication.

A broadcast wave transmitted from a broadcasting station is received by the antenna 101 and transferred to the tuner 102. The tuner 102 selects a channel to be reproduced from the broadcast wave received by the antenna 101. A transport stream transmitted on the channel selected by the tuner 102 is temporarily stored by unit of TS packet in the broadcast wave buffer 124.

When a predetermined number of TS packets are recorded in the broadcast wave buffer 124, the TS I/F 103 generates an interrupt signal to the input control unit 106 to input the TS packets in the syntax analysis unit 107. The predetermined number may be, for example, 1 here but may be a different value in accordance with the equipment of the contents reproducing apparatus. If the input control unit 106 switches the switch 122 to the TS I/F 103 by the interrupt signal, the TS I/F 103 transfers the predetermined number of TS packets to the syntax analysis unit 107 via the switch 122. A method of transferring the predetermined number of TS packets is not limited here but, for example, a method of further preparing a buffer for the predetermined number of TS packets, copying the TS packets in the buffer, and retrieving the copied TS packets by the syntax analysis unit 107 may be provided. In addition, the syntax analysis unit 107 may access the broadcast wave buffer 124 and directly retrieve the TS packets.

The reproduction mode input unit 104 notifies the reproduction mode control unit 105 of change in the reproduction mode of the contents reproducing apparatus. In the contents reproducing apparatus shown in FIG. 1, at least three kinds of reproduction modes, i.e. normal reproduction mode, time shift storage mode and time shift reproduction mode are provided. In the normal reproduction mode, the contents reproducing apparatus sequentially decodes and reproduces the video and audio data in the TS packet received from the broadcast wave. In the time shift storage mode, the contents reproducing apparatus continues storing the TS packet received from the broadcast wave in the buffer 109. In the time shift reproduction mode, the contents reproducing apparatus sequentially decodes and reproduces the video and audio data in the TS packet stored in the buffer 109 while storing the TS packet received subsequently from the broadcast wave in the time shift storage mode.

The change of the reproduction mode is made under user's directions such as key operations or the like or, if the contents reproducing apparatus is a mobile radio terminal, by events such as call-in or the like. More specifically, if the user cannot watch or listen to the video and audio data while the contents reproducing apparatus is reproducing contents in the normal reproduction mode, the instruction for change of the reproduction mode is input to the reproduction mode input unit 104, by the key operation or the like for changing the reproduction mode to the time shift storage mode. Then, if the user becomes capable of starting watching and listening again, the instruction for change of the reproduction mode is input to the reproduction mode input unit 104, by the key operation or the like for changing the reproduction mode from the time shift storage mode to the time shift reproduction mode or normal reproduction mode. In a case where processes of filtering, decoding and reproducing all the TS packets stored in the buffer 109 are completed (various kinds of processes catch up the broadcast wave) by the user's operation such as fast play or the like while the contents reproducing apparatus is reproducing contents in the time shift reproduction mode, the contents reproducing apparatus automatically shifts from the time shift reproduction mode to the normal reproduction mode, since the currently received broadcast wave are to be reproduced. If the contents reproducing apparatus is a mobile radio terminal, the reproduction mode may be automatically shifted to the time shift storage mode, since the user does not become watching or listening to the video and audio data while speech communication.

The reproduction mode control unit 105 notifies the input control unit 106, PID filter 108 and STC control unit 111 of the current reproduction mode, and changes the switch 123 on the basis of the current reproduction mode. In other words, if the contents reproducing apparatus becomes in the normal reproduction mode, the reproduction mode control unit 105 changes the switch 123 such that the PCR included in the TS packet of the broadcast wave is input to the STC control unit 111. If the contents reproducing apparatus shifts to the time shift reproduction mode, the reproduction mode control unit 105 changes the switch 123 such that the PCR corrected by the correction unit 110 is input to the STC control unit 111. If the contents reproducing apparatus is in the time shift storage mode, the control of the switch 123 is not particularly limited due to no input to the STC control unit 111.

The input control unit 106 changes the switch 122 on the basis of the interrupt signal from the TS I/F 103 and the notification of the reproduction mode from the reproduction mode control unit 105. In other words, if the input control unit 106 receives from the reproduction mode control unit 105 a notification that the stream reproducing apparatus is in the normal reproduction mode or time shift storage mode, the input control unit 106 changes the switch 122 such that the TS packet transferred from the TS I/F 103 is input to the syntax analysis unit 107. In addition, if the input control unit 106 receives from the reproduction mode control unit 105 a notification that the stream reproducing apparatus is in the time shift reproduction mode, the input control unit 106 changes the switch 122 such that the TS packet stored in the buffer 109 is input to the syntax analysis unit 107. However, when the interrupt signal is input from the TS I/F 103, the switch 122 is once changed to input the TS packet transferred from the TS I/F 103 to the syntax analysis unit 107, and the switch 122 is changed again to the buffer 109 side. Furthermore, the input control unit 106 notifies the correction unit 110 of whether the TS packet input to the syntax analysis unit 107 is the TS packet transferred from the TS I/F 103 or the TS packet stored in the buffer 109.

The syntax analysis unit 107 analyzes each syntax from the TS packet transferred via the switch 122 and transfers the TS packet to the PID filter 108. In particular, the syntax analysis unit 107 analyzes the syntaxes included in TS header, adaptation field and PES header in the TS packet.

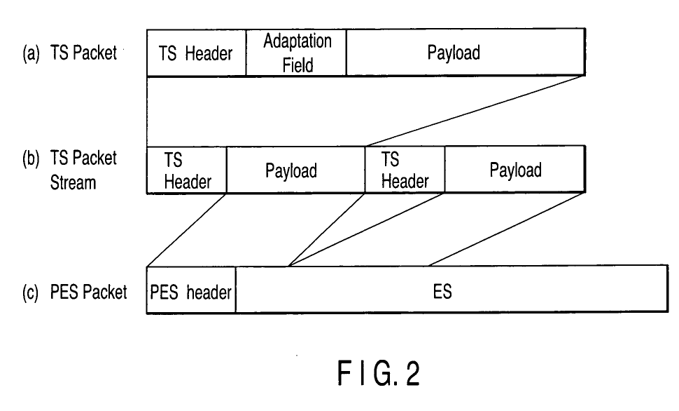

As shown in FIG. 2, a TS packet (a) led by a 4-byte TS header, and configured as a 188-byte fixed length packet consisting of an adaptation field as an optionally settable field and a payload. Also, as shown in FIG. 2, a TS packet is arranged in a transport stream (b). In FIG. 2, a TS header and an adaptation field of the TS packet contained in the transport stream are expressed as a header for the sake of convenience.

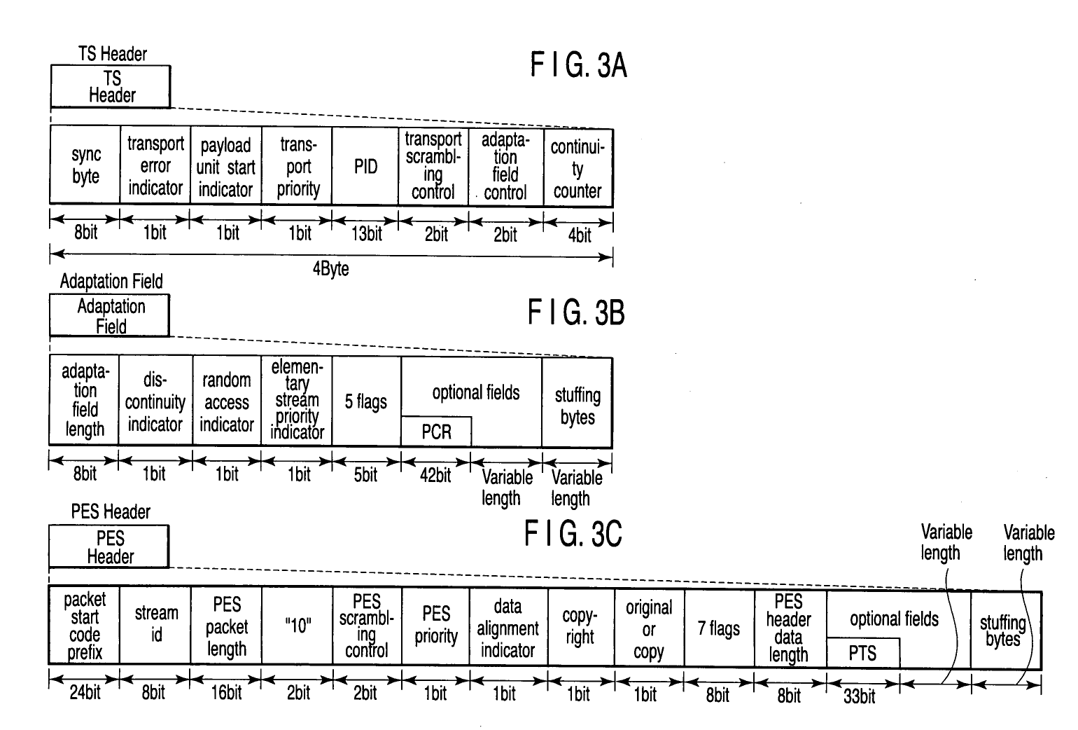

As shown in FIG. 3A, a TS header includes a 13-bit length packet ID (PID), which makes it possible to determine which of the video data and audio data is transmitted by a TS packet. Namely, as the same video data and audio data have the same PID, the ES before being packetized can be restored by using a PID.

Further, a TS header includes a 1-bit transport error indicator which shows whether a TS packet includes an error, and a 2-bit length adaptation field control indicating the presence or absence of an adaptation field or payload. Here, as an adaptation field control, “11” is defined as “an adaptation field exists, and payload exists”, “10” is defined as “an adaptation field exists, and a payload does not exist”, “01” is defined as “an adaptation field does not exist, and a payload exists”, and “00” is defined as “RFU (Reserved for Future Use)”, respectively.

A TS header also has a sync byte indicating the beginning of the TS packet. A TS header also has a payload unit start indicator, which informs the decoder that a new PES packet starts from a payload in the TS packet. A TS header also has a transport priority indicating the importance of the TS packet, and a 2-bit length transport scrambling control indicating the presence or absence of a scramble of a payload in the TS packet. A TS header also has a 4-bit length continuity counter for detecting whether some of TS packets having the same PID are discarded halfway.

As shown in FIG. 3B, an adaptation field has a variable length optional field, and a 42-bit length PCR is included in this optional field. Further, an adaptation field has an 8-bit length adaptation field length, a 1-bit discontinuity indicator indicating the presence or absence of a discontinuity of time base, a random access indicator, an elementary stream priority indicator, 5 flags including a 1-bit PCR flag indicating the presence or absence of PCR in the adaptation field, and variable length stuffing bytes.

As shown in FIG. 2, a payload accommodates part of a PES packet (c), which is packetized by adding a header called a PES header to ES.

As shown in FIG. 3C, a PES header contains the PTS of the first frame in the PES packet in a 33-bit length field. Here, a PES header consists of a 24-bit length packet start prefix, an 8-bit length stream ID, a 16-bit length PES packet length, “10”, a 2-bit length PES scrambling control, a PES priority, a data alignment indicator, a copy right, an original or copy, 7 flags, an 8-bit length PES header length, a variable length optional field to accommodate the PTS, and variable length stuffing bytes.

In accordance with the PID included in the TS header in the TS packet transferred from the syntax analysis unit 107, The PID filter 108 assigns the TS packet. More specifically, the PID filter 108 assigns the TS packet in accordance with the PID, by referring to table information called program map table (PMT) included in each program. In other words, by retrieving the PMT by using the PID as a key, the PID filter 108 obtains information that, for example, the TS packet includes the video data or audio data, and then discriminates destination of the assigned TS packet. If the program to be viewed is changed by the user's operation or the like, the PMT of the changed program is reset in the PID filter 108. The destination of the assigned TS packet discriminated by the PID filter 108 is also changed in the reproduction mode notified by the reproduction mode control unit 105.

In a case where the contents reproducing apparatus is in the normal reproduction mode, the PID filter 108 transmits the TS packet to the PES extraction unit 114 if the video data is included in the TS packet and transmits the TS packet to the PES extraction unit 118 if the audio data is included in the TS packet. If the TS packet includes the PCR, the PID filter 108 assigns the PCR to the STC control unit 111. If the PID filter 108 cannot retrieve the PID of the TS packet from the PMT, the PID filter 108 abandons the TS packet.

In a case where the contents reproducing apparatus is in the time shift storage mode, the PID filter 108 transfers the TS packet to the buffer 109. At this time, if the PID filter 108 cannot retrieve the PID of the TS packet from the PMT, the PID filter 108 may preliminarily abandon the TS packet.

In a case where the contents reproducing apparatus is in the time shift reproduction mode, if the TS packet is a TS packet transferred from the TS I/F 103, the PID filter 108 transfers the TS packet to the buffer 109. At this time, if the TS packet includes the PCR, the PID filter 108 assigns the PCR to the STC control unit 111. In a case where the TS packet is a TS packet transferred from the buffer 109, the PID filter 108 transmits the TS packet to the PES extraction unit 114 if the video data is included in the TS packet or transmits the TS packet to the PES extraction unit 118 if the audio data is included in the TS packet. In addition, in a case where the TS packet includes the PCR, the PID filter 108 assigns the PCR to the STC control unit 111. If the PID filter 108 cannot retrieve the PID of the TS packet from the PMT, the PID filter 108 abandons the TS packet.

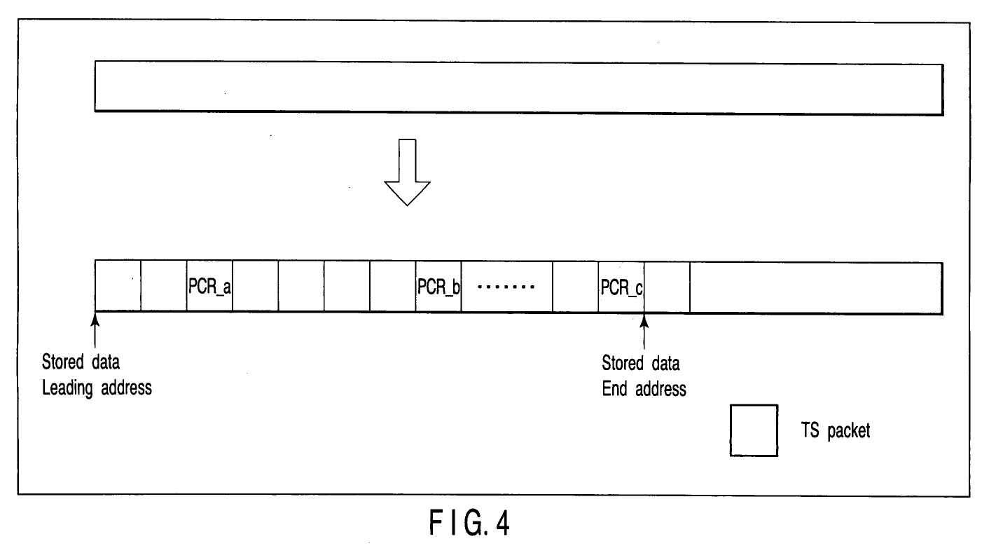

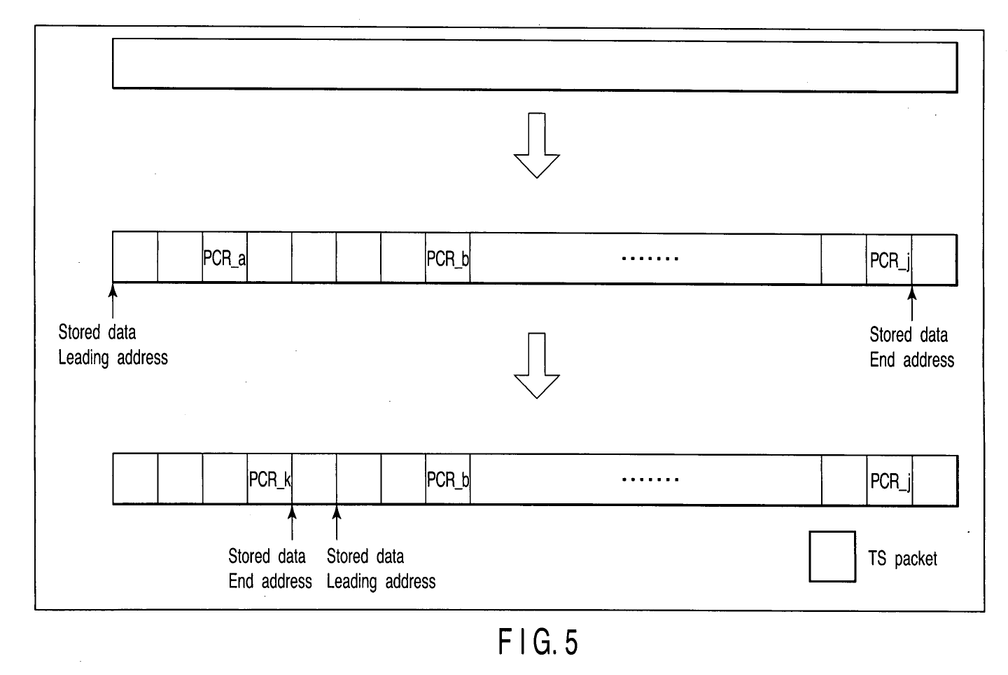

The buffer 109 stores the TS packet from the broadcast wave in a case where the contents reproducing apparatus is in the time shift storage mode or the time shift reproduction mode. In the following descriptions, the buffer 109 is a ring buffer and has a leading pointer indicating the leading address of the stored data and an end pointer indicating the end address of the stored data. In other words, the buffer 109 stores the TS packet in the order from the leading part as shown in FIG. 4. As shown in FIG. 5, if the stored data exceeds the capacity of the buffer 109, the address indicated by the end pointer is rewritten to the leading address of the buffer 109 and the older data of the storing timing is sequentially overwritten. Overwriting of the buffer 109 is detected when, for example, the stored data exceeds the capacity of the buffer 109 and the address indicated by the end pointer comes back to the leading part and rewritten to the leading address of the buffer 109.

The correction unit 110 corrects the PCR assigned by the PID filter 108 in a case where the contents reproducing apparatus is in the time shift reproduction mode. More specifically, the correction unit 110 first discriminates whether or not the STC 112 stops. For example, the correction unit 110 discriminates the stop of the STC 112 by receiving a notification of restart of the STC 112 from the STC control unit 111 or referring to the STC value counted by the STC counter 113, or on the basis of the other information.

If the STC 112 has not yet been started, when the correction unit 110 first receives the PCR included in the TS packet transferred from the buffer 109, the correction unit 110 notifies the STC control unit 111 of the PCR via the switch 123. The STC control unit 111 restarts the STC 112 after loading the PCR into the STC counter 113.

If the STC 112 has been restarted, the correction unit 110 corrects the PCR included in the TS packet transferred from the TS I/F 103 and notifies the STC control unit 111 of the corrected PCR via the switch 123. The correction of the PCR is performed in the following manner.

When the correction unit 110 first receives the PCR included in the TS packet transferred from the TS I/F 103 after the restart of the STC 112, the correction unit 110 calculates a difference between the PCR and the current STC value as ΔPCR. After that, every time the correction unit 110 receives the PCR included in the TS packet transferred from the TS I/F 103, the correction unit 110 notifies the STC control unit 111 of a value obtained by subtracting ΔPCR from the PCR as the corrected PCR, via the switch 123.

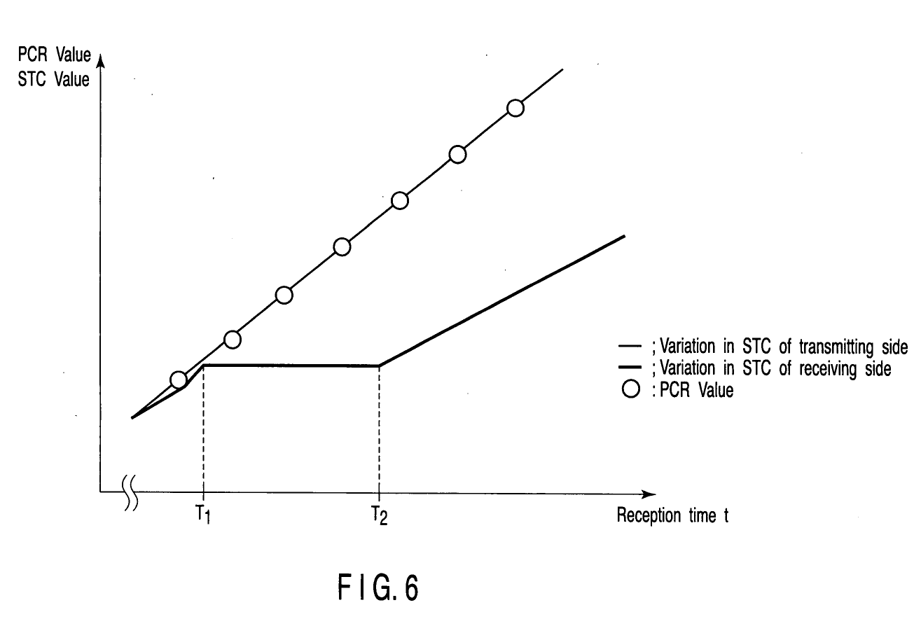

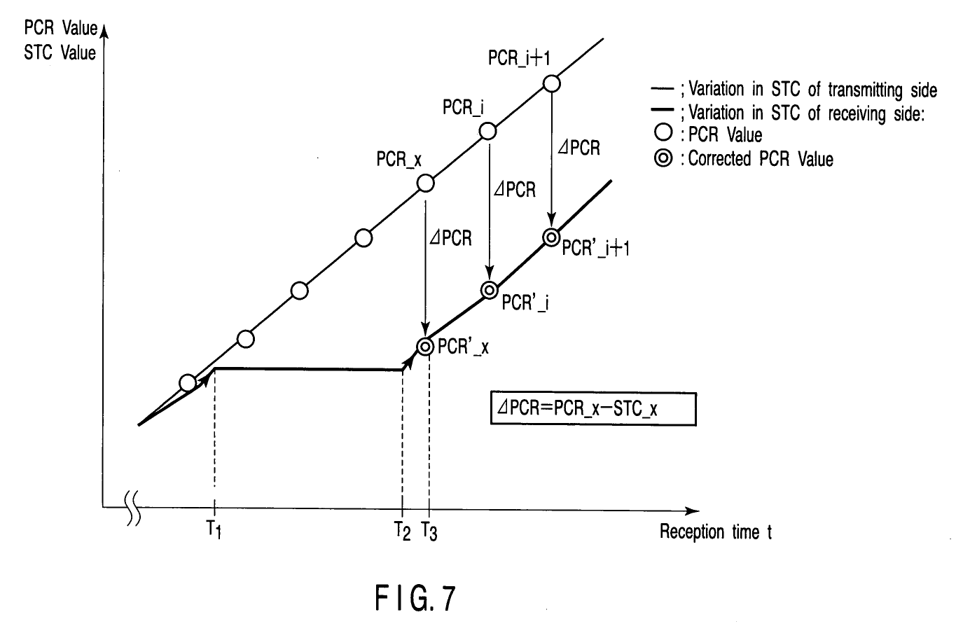

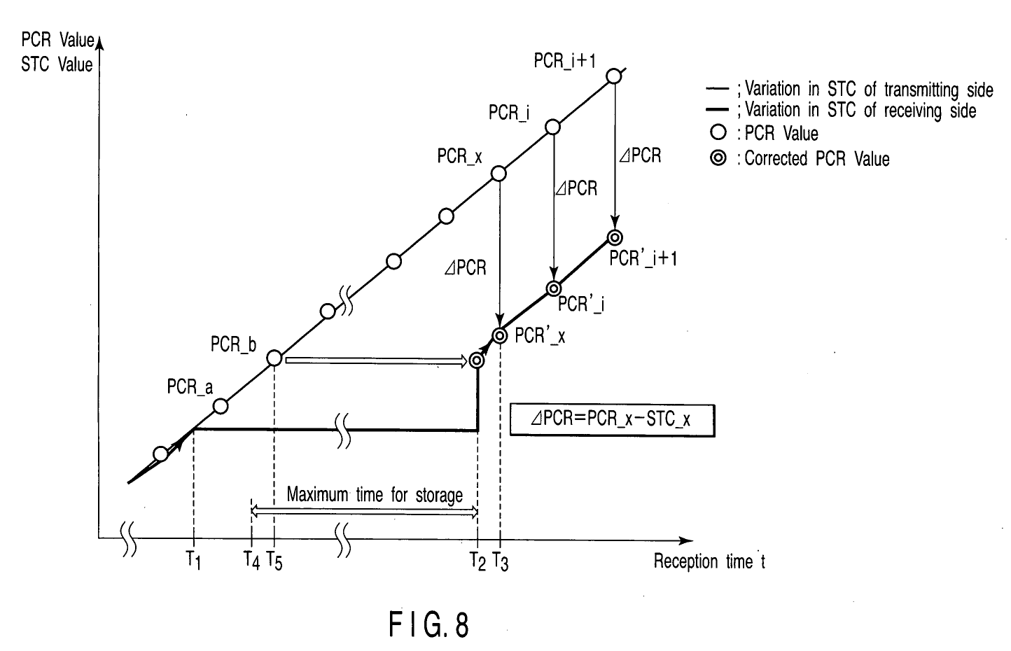

A technical significance of correcting the PCR by the correction unit 110 will be described below with reference to FIG. 6, FIG. 7 and FIG. 8.

If the PCR is not corrected by the correction unit 110, the STC 112 cannot synchronize with the transmitting side since the STC control unit 111 cannot obtain a valid PCR and perform the clock recovery. Therefore, as shown in FIG. 6, if the STC 112 is more delayed than the STC of the transmitting side, the speed at which the video and audio PES packets are stored in the buffers 115 and 119 is higher than the speed at which the PES packets are decoded by the decoders 116 and 120, and the buffers 115 and 119 may overflow.

On the other hand, if the PCR is corrected by the correction unit 110, the STC 112 can synchronize with the transmitting side since the STC control unit 111 can perform the clock recovery by using the corrected PCR. Therefore, occurrence of the overflow in the buffers 115 and 119 can be prevented. More specifically, the correction unit 110 corrects the PCR as shown in FIG. 7 if the buffer 109 is not overwritten, or corrects the PCR as shown in FIG. 8 if the buffer 109 is overwritten. The correction of the PCR performed by the correction unit 110 will be described with reference to FIG. 7 and FIG. 8.

In FIG. 7, the reproduction mode of the contents reproducing apparatus is the normal reproduction mode until time T1, the time shift storage mode from time T1 to time T2, and the time shift reproduction mode after time T2. Until the time T1, the STC 112 is in synchronization with the transmitting side since the STC control unit 111 performs the general clock recovery by using the PCR in the received TS packet. When the reproduction mode is changed to the time shift storage mode at the time T1, the STC control unit 111 stops the STC 112. Therefore, the STC value counted by the STC counter 113 is fixed, and the received TS packets are sequentially stored in the buffer 109. When the reproduction mode is changed to the time shift reproduction mode at the time T2, the STC value counted by the STC counter 113 is increased at the same speed as that before stopping since the STC control unit 111 restarts the STC 112 with the frequency obtained before stopping. PCR_x included in the TS packet received at time T3 is assigned from the PID filter 108 and input to the correction unit 110. When the correction unit 110 receives the PCR_x, the correction unit 110 obtains STC_x corresponding to the STC value of the STC counter 113 at this time and performs subtraction from PCR_x. The subtraction result is maintained as ΔPCR. The correction unit 110 outputs the PCR value input thereafter which is obtained by subtraction of ΔPCR as the corrected PCR, and the STC control unit 111 performs the clock recovery using the corrected PCR. Therefore, the STC 112 can synchronize with the transmitting side.

In FIG. 8, the reproduction mode of the contents reproducing apparatus is the normal reproduction mode until the time T1, the time shift storage mode from the time T1 to the time T2, and the time shift reproduction mode after the time T2. Until the time T1, the STC 112 can synchronize with the transmitting side since the STC control unit 111 performs the general clock recovery by using the PCR in the received TS packet. When the reproduction mode is changed to the time shift storage mode at the time T1, the STC control unit 111 stops the STC 112. Therefore, the STC value counted by the STC counter 113 is fixed, and the received TS packets are sequentially stored in the buffer 109. However, since the amount of the TS packet transferred to the buffer 109 in the time shift storage mode exceeds the capacity of the buffer 109, it is assumed that older data is sequentially overwritten and the TS packet before time T4, for example, the TS packet including PCR_a is lost. When the STC control unit 111 thus detects overwriting of the buffer 109, the STC control unit 111 does not restart the STC 112, but awaits transfer of the TS packet including PCR_b, i.e. the first PCR in the data stored in the buffer 109 even if the reproduction mode is shifted to the time shift reproduction mode. When the TS packet including PCR_b is transferred, the correction unit 110 notifies the STC control unit 111 of the PCR_b. Since the STC control unit 111 loads the PCR_b into the STC counter 113 and restarts the STC 112 with the frequency obtained before the stop, the STC value counted by the STC counter 113 is increased at the same speed as that before the stop. After that, PCR_x included in the TS packet received at the time T3 is assigned from the PID filter 108 and input to the correction unit 110, similarly to the above-described case. When the correction unit 110 receives the PCR_x, the correction unit 110 obtains STC_x corresponding to the STC value of the STC counter 113 at this time and performs subtraction from PCR_x. The subtraction result is maintained as ΔPCR. The correction unit 110 outputs the PCR value input thereafter which is obtained by subtraction of ΔPCR as the corrected PCR, and the STC control unit 111 performs the clock recovery using the corrected PCR. Therefore, the STC 112 can synchronize with the transmitting side.

The STC control unit 111 compares the PCR input via the switch 123 with the STC value from the STC counter 113. The STC control unit 111 controls the STC 112 to raise the frequency if the STC value is smaller than the PCR, or controls the STC 112 to lower the frequency if the STC value is greater than the PCR. When the STC control unit 111 receives from the input control unit 106 a notification that the reproduction mode of the contents reproducing apparatus has been changed to the time shift storage mode, the STC control unit 111 stops the STC 112. When the STC control unit 111 receives from the input control unit 106 a notification that the reproduction mode of the contents reproducing apparatus has been changed to the time shift reproduction mode, the STC control unit 111 restarts the STC 112. However, if a part of the TS packet stored in the buffer 109 is overwritten and lost as described above, the STC control unit 111 restarts the STC 112 after loading the initial PCR stored in the buffer 109 into the STC counter 113 as an initial value.

The STC 112 generates the STC on the basis of the frequency determined by the STC control unit 111, and inputs the STC in the STC counter 113.

The STC counter 113 inputs the STC value counted by the STC 112 in the decoders 116 and 120. The STC value is also input in the STC control unit 111 for the clock recovery.

The PES extraction unit 114 extracts the PES packet having the video ES transmitted from the PID filter 108, and transfers the PES packet to the buffer 115. The buffer 115 temporarily stores the PES packet extracted by the PES extraction unit 114.

The decoder 116 obtains the PES packet from the buffer 115 at the timing determined on the basis of the STC value from the STC counter 113, decodes the ES in the PES packet, and obtains the video data. The display unit 117 reproduces the video data decoded by the decoder 116.

The PES extraction unit 118 extracts the PES packet having the audio ES transferred from the PID filter 108, and transfers the PES packet to the buffer 119. The buffer 119 temporarily stores the PES packet extracted by the PES extraction unit 118.

The decoder 120 obtains the PES packet from the buffer 119 at the timing determined on the basis of the STC value from the STC counter 113, decodes the ES in the PES packet, and obtains the audio data. The speaker 121 reproduces the audio data decoded by the decoder 120.

The switch 122 changes the input of the syntax analysis unit 107 on the basis of the control signal from the input control unit 106. In other words, either the TS packet stored in the buffer 109 or the TS packet transferred from the TS I/F 103 is input to the syntax analysis unit 107.

The switch 123 changes the input of the STC control unit 111 on the basis of the control signal from the reproduction mode control unit 105. In other words, either the PCR included in the TS packet of the general broadcast wave or the PCR corrected by the correction unit 110 is input to the STC control unit 111.

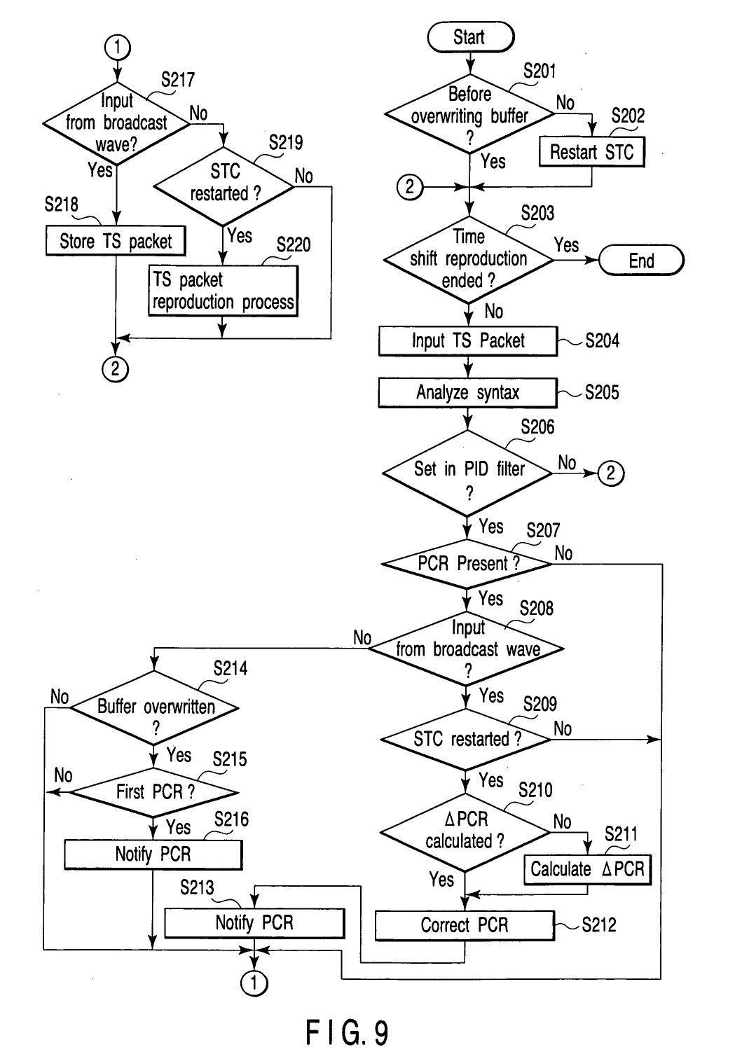

The time shift reproducing operation of the contents reproducing apparatus according to the embodiment of the present invention will be described below with reference to a flowchart shown in FIG. 9.

When the reproduction mode control unit 105 receives from the reproduction mode input unit 104 an instruction for shifting to the time shift reproduction, the contents reproducing apparatus starts the time shift reproduction. First, it is discriminated whether or not the buffer 109 is overwritten. The process proceeds to step S202 if the buffer 109 is not overwritten or proceeds to step S203 if the buffer 109 is overwritten (step S201). In step S202, the STC control unit 111 restarts the STC 112. The process proceeds to step S203.

In step S203, it is discriminated whether or not the time shift reproduction is ended. More specifically, end of the time shift reproduction is discriminated by detecting, for example, whether the leading address of the stored data in the buffer 109 has caught up with the end address. When the time shift reproduction is ended, the contents reproducing apparatus ends the time shift reproduction and shifts to the normal reproduction mode. When the time shift reproduction is continued, the syntax analysis unit 107 inputs the TS packet from the TS I/F 103 or the buffer 109 (step S204). Next, the syntax analysis unit 107 analyzes the syntax of the input TS packet and transfers the TS packet to the PID filter 108 (step S205). The PID filter 108 discriminates whether or not the PID of the TS packet is set, by referring to the PMT (step S206). If the PID is not present in the PMT, the process returns to step S203 since the TS packet is not a TS packet to be processed. If the PID is present in the PMT, the process proceeds to step S207.

In step S207, the PID filter 108 discriminates whether or not the TS packet to be processed includes the PCR. If the TS packet includes the PCR, the process proceeds to step S208. If the TS packet does not include the PCR, the process proceeds to step S217. In step S208, the PID filter 108 discriminates whether or not the TS packet to be processed is transferred from the TS I/F 103. If the TS packet to be processed is transferred from the TS I/F 103, the process proceeds to step S209. If the TS packet to be processed is not transferred from the TS I/F 103, the process proceeds to step S214.

In step S209, it is discriminated whether or not the STC 112 has restarted. If the STC 112 has restarted, the process proceeds to step S210. If the STC 112 has not restarted, the process proceeds to step S217. In step S210, it is discriminated whether or not the correction unit 110 has calculated ΔPCR. If ΔPCR has been calculated, the process proceeds to step S212. If ΔPCR has not been calculated, the process proceeds to step S211. In step S211, the correction unit 110 calculates ΔPCR. In other words, the correction unit 110 obtains ΔPCR by subtracting the STC value of the STC counter 113 from the transferred PCR, and the process proceeds to step S212. In step S212, the correction unit 110 subtracts ΔPCR from the transferred PCR and sets the subtraction result as the corrected PCR. Next, the correction unit 110 notifies the STC control unit 111 of the PCR corrected in step S212, and the process proceeds to step S217 (step S213).

In step S214, it is discriminated whether or not the buffer 109 is overwritten before the start of the time shift reproduction mode. In other words, the same discrimination as that described in step S201 is performed. If the buffer 109 is overwritten, the process proceeds to step S215. If the buffer 109 is not overwritten, the process proceeds to step S217. In step S215, it is discriminated whether or not the PCR is a PCR first transferred from the buffer 109 after the start of the time shift reproduction mode. If the PCR is the first PCR, the process proceeds to step S216. If the PCR is not the first PCR, the process proceeds to step S217. In step S216, the PCR is loaded into the STC counter 113, the STC control unit 111 restarts the STC 112, and the process proceeds to step S217.

In step S217, it is discriminated whether or not the TS packet is transferred from the TS I/F 103. In other words, the same discrimination as that described in step S208 is performed. If the TS packet is transferred from the TS I/F 103, the process proceeds to step S218. If the TS packet is not transferred from the TS I/F 103, the process proceeds to step S219. In step S218, the TS packet is stored in the buffer 109, and the process returns to step S203.

In step S219, it is discriminated whether or not the STC 112 has restarted. In other words, the same discrimination as that described in step S209 is performed. If the STC 112 has restarted, the process proceeds to step S220. If the STC 112 has not restarted, the process returns to step S203. In step S220, the process of reproducing the TS packet is performed and the process returns to step S203. More specifically, the video and audio data obtained by extracting the PES packet from the TS packet and decoding the PES packet are reproduced.

In the above-described embodiment, the PCR from the broadcast wave is corrected and the clock recovery is performed by using the corrected PCR, in the time shift reproduction mode. Therefore, the contents reproducing apparatus capable of reproduction synchronous with the transmitting side even in the time shift reproduction mode can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

For example, both the video data and the audio data can be reproduced but either the video data or the audio data may be reproduced. In other words, if the video data alone is reproduced, the PES extraction unit 118, the buffer 119, the decoder 120, and the speaker 121 may be removed from the contents reproducing apparatus shown in FIG. 1. If the audio data alone is reproduced, the PES extraction unit 114, the buffer 115, the decoder 116, and the display unit 117 may be removed from the contents reproducing apparatus shown in FIG. 1.

The present invention can be otherwise variously modified within a scope which does not depart from the gist of the present invention.

What is claimed is:

1. A contents reproducing apparatus, comprising:
a receiving unit configured to receive a first packet having an elementary stream in which encoded video or audio data is stored, and a second packet having the elementary stream and a program clock reference;
a counter configured to count a system time clock and output the counted system time clock as a system time clock value;
a first buffer configured to store the first and second packets in an order of reception in a time shift reproduction mode and a time shift storage mode to pre-store the first and second packets prior to the time shift reproduction mode;
a correcting unit configured to correct the program clock reference included in the second packet received by the receiving unit by using the system time clock value and output the corrected program clock reference, in the time shift reproduction mode;
a control unit configured to control the system time clock in accordance with the corrected program clock reference and the system time clock value, in the time shift reproduction mode;
a second buffer configured to temporarily store the elementary stream included in the first and second packets stored in the first buffer, in the time shift reproduction mode;
a decoder configured to decode the video or audio data from the elementary stream stored in the second buffer, at a timing determined in accordance with the system time clock value; and
a reproducing unit configured to reproduce the video or audio data.

2. The apparatus according to claim 1, wherein the control unit is configured to control the system time clock in accordance with the program clock reference included in the second packet received by the receiving unit and the system time clock value, in a normal reproduction mode, and
the second buffer is configured to temporarily store the elementary stream included in the first and second packets received by the receiving unit, in the normal reproduction mode.

3. The apparatus according to claim 1, wherein, in the time shift reproduction mode, the correcting unit is configured to calculate a difference between the program clock reference and the system time clock value, and output a value obtained by subtracting the difference from the program clock reference input thereafter as the corrected program clock reference, if the program clock reference included in the second packet first received by the receiving unit is input.

4. The apparatus according to claim 1, wherein, in the time shift reproduction mode, the counter is configured to load the program clock reference included in the second packet stored most previously in the first buffer, of the second packet, as an initial value of the system time clock, if the first buffer is overwritten in the time shift storage mode prior to the time shift reproduction mode.

5. The apparatus according to claim 4, wherein, in the time shift reproduction mode, the first packet stored more previously than the second packet stored most previously in the first buffer, of the second packet, is abandoned.

6. A contents reproducing apparatus, comprising:
a receiving unit configured to receive a first packet having an elementary stream in which encoded video or audio data is stored, and a second packet having the elementary stream and a reference clock information;
a counter configured to count a system clock and output the counted system clock as a system clock value;
a first buffer configured to store the first and second packets in an order of reception in a time shift reproduction mode and a time shift storage mode to pre-store the first and second packets prior to the time shift reproduction mode;
a correcting unit configured to correct the reference clock information included in the second packet received by the receiving unit by using the system clock value and output the corrected reference clock information, in the time shift reproduction mode;
a control unit configured to control the system clock in accordance with the corrected reference clock information and the system clock value, in the time shift reproduction mode;
a second buffer configured to temporarily store the elementary stream included in the first and second packets stored in the first buffer, in the time shift reproduction mode;
an audio decoder configured to decode the audio data from the elementary stream stored in the second buffer, at a timing determined in accordance with the system clock value;
a video decoder configured to decode the video data from the elementary stream stored in the second buffer, at a timing determined in accordance with the system clock values;
a first reproducing unit configured to reproduce the audio data; and
a second reproducing unit configured to reproduce the video data.

7. The apparatus according to claim 6, wherein the control unit is configured to control the system clock in accordance with the reference clock information included in the second packet received by the receiving unit and the system clock value, in a normal reproduction mode, and
the second buffer is configured to temporarily store the stream included in the first and second packets received by the receiving unit, in the normal reproduction mode.

8. The apparatus according to claim 6, wherein, in the time shift reproduction mode, the correcting unit is configured to calculate a difference between the reference clock information and the system clock value, and output a value obtained by subtracting the difference from the reference clock information input thereafter as the corrected reference clock information, if the reference clock information included in the second packet first received by the receiving unit is input.

9. The apparatus according to claim 6, wherein, in the time shift reproduction mode, the counter is configured to load the reference clock information included in the second packet stored most previously in the first buffer, of the second packet, as an initial value of the system clock, if the first buffer is overwritten in the time shift storage mode prior to the time shift reproduction mode.

10. The apparatus according to claim 9, wherein, in the time shift reproduction mode, the first packet stored more previously than the second packet stored most previously in the first buffer, of the second packet, is abandoned.

11. A cellular phone, comprising:
a radio circuit configured to transmit and receive a coded speech signal to and from a base station;
a speech codec configured to code speech signal to be transferred to the base station, and decode the received coded speech signal;
a receiving unit configured to receive a first packet having an elementary stream in which encoded video or audio data is stored, and a second packet having the elementary stream and a reference clock information;
a counter configured to count a system clock and output the counted system clock as a system clock value;
a first buffer configured to store the first and second packets in an order of reception in a time shift reproduction mode and a time shift storage mode to pre-store the first and second packets prior to the time shift reproduction mode;
a correcting unit configured to correct the reference clock information included in the second packet received by the receiving unit by using the system clock value and output the corrected reference clock information, in the time shift reproduction mode;
a control unit configured to control the system clock in accordance with the corrected reference clock information and the system clock value, in the time shift reproduction mode;
a second buffer configured to temporarily store the elementary stream included in the first and second packets stored in the first buffer, in the time shift reproduction mode;
an audio decoder configured to decode the audio data from the elementary stream stored in the second buffer, at a timing determined in accordance with the system clock value;
a video decoder configured to decode the video data from the elementary stream stored in the second buffer, at a timing determined in accordance with the system clock values;
a first reproducing unit configured to reproduce the audio data; and
a second reproducing unit configured to reproduce the video data.

12. The cellular phone according to claim 11, wherein
the control unit is configured to control the system clock in accordance with the reference clock information included in the second packet received by the receiving unit and the system clock value, in a normal reproduction mode, and
the second buffer is configured to temporarily store the stream included in the first and second packets received by the receiving unit, in the normal reproduction mode.

13. The cellular phone according to claim 11, wherein, in the time shift reproduction mode, the correcting unit is configured to calculate a difference between the reference clock information and the system clock value, and output a value obtained by subtracting the difference from the reference clock information input thereafter as the corrected reference clock information, if the reference clock information included in the second packet first received by the receiving unit is input.

14. The cellular phone according to claim 11, wherein, in the time shift reproduction mode, the counter is configured to load the reference clock information included in the second packet stored most previously in the first buffer, of the second packet, as an initial value of the system clock, if the first buffer is overwritten in the time shift storage mode prior to the time shift reproduction mode.

15. The cellular phone according to claim 14, wherein, in the time shift reproduction mode, the first packet stored more previously than the second packet stored most previously in the first buffer, of the second packet, is abandoned.
